(19) United States
(12) Patent Application Publication
(10) Pub. No.: US 2023/0154295 A1
(43) Pub. Date: May 18, 2023

(54) PASSIVE HAPTIC DEVICE

(71) Applicant: Moving Magnet Technologies, Besançon (FR)

(72) Inventors: Jean-Daniel Alzingre, Larnod (FR); Batiste Galmes, Besançon (FR)

(21) Appl. No.: 17/995,231

(22) PCT Filed: Mar. 25, 2021
(86) PCT No.: PCT/FR2021/050513

§ 371 Date: Sep. 30, 2022

(30) Foreign Application Priority Data
Mar. 31, 2020 (FR) FR2003203

(51) Int. Cl. G08B 6/00; B06B 1/04

(52) U.S. Cl. CPC G08B 6/00; B06B 1/04

(57) ABSTRACT

The present disclosure relates to a passive haptic device comprising a mechanical member moving with respect to a second mechanical member, one of the mechanical members having a plurality of magnetized zones spaced periodically according to a pitch P1, the other of the mechanical members having a second plurality of magnetized zones spaced periodically according to a pitch P2, a force that varies periodically as a function of the relative position of the mechanical members being created by the magnetic interaction between the mechanical members, the magnetic interaction varying according to a period Pt, wherein all the magnetized zones of at least one of the mechanical members are magnetized in the same sense.

### CROSS-REFERENCE TO RELATED APPLICATIONS

This application is a national phase entry under 35 U.S.C. § 371 of International Patent Application PCT/FR2021/050513, filed Mar. 25, 2021, designating the United States of America and published as International Patent Publication WO 2021/198591 A1 on Oct. 7, 2021, which claims the benefit under Article 8 of the Patent Cooperation Treaty to French Patent Application Serial No. FR2003203, filed Mar. 31, 2020.

### TECHNICAL FIELD

The present disclosure relates to a passive haptic device, that is to say, one that can be manipulated by the finger or the hand or even possibly by the foot of a user and that provides a variable force feedback, and does so without consuming electric energy.

The present disclosure applies to, for example, a computer control interface or to a control interface inside a motor vehicle or else to a control interface of a household appliance.

### BACKGROUND

Manual haptic devices angularly indexed in a purely magnetic manner are known. These devices are based on a magnetic field source U.S. Pat. No. 3,885,560, or two magnetic field sources U.S. Pat. No. 3,934,216, oriented unidirectionally and constituted by permanent magnets, associated with soft ferromagnetic flux looping parts. These parts are arranged opposite each other and define a magnetic air gap. They are cut in such a way as to create a magnetic permeance of variable air gap according to the phase difference between the fixed parts and the moving parts. When the teeth of the fixed assembly face the teeth of the mobile assembly, the permeance is minimal and the position is then indexed. These looping parts have the same number of teeth on the fixed part and on the moving part. This number is equal to the number of stable positions sought.

There are also patent applications, such as Federal Republic of Germany patent application publication DE4035011, that describe how to achieve magnetic angular indexing between two assemblies. This is done by way of a plurality of different polarities of magnets fixed to one of the moving parts relative to the other. The magnetic fluxes of these magnets are channeled by soft ferromagnetic parts that describe a magnetic air gap of variable reluctance during the relative rotation of the two assemblies.

French Utility certificate application FR2935497 describes an angular indexing device based on the use of magnetic couplings between a fixed part and a rotating part. Each of these parts has alternating magnet poles (North and South) opposite those of the other part. The parts have the same number of magnet poles, equal to twice the indexed positions sought. A position is indexed when all the magnets of a given polarity on the mobile assembly are aligned with all the magnets of opposite polarity on the fixed assembly. This application does not disclose a soft ferromagnetic flux looping material.

The drawbacks, identified as such, in the prior art are the complication of multipolar assemblies (when magnets are alternated in ferromagnetic structures), the complexity of producing large numbers of indexed positions, and the practical difficulty of magnetizing, in large number and on a single magnet, magnetic poles with an alternating variation of polarity.

Moreover, in many haptic devices, it is often necessary to implement a position sensor in order to be able to control the operation of a device, such as, for example, the movement of a computer pointer when the haptic interface is a mouse, or of a cursor on a dashboard screen, these examples not being limiting. The devices of the prior art often use optical, resistive or magnetic sensors that are juxtaposed with the haptic device, making the solution either bulky or uneconomical.

Finally, the passive haptic devices of the prior art have mechanical members made of soft ferromagnetic material in areas where the magnetic induction varies greatly by the use of the devices. These variations induce losses of magnetic origin (by induced currents, by hysteresis effect, etc.) that bring significant friction, which is detrimental to the quality of the haptic rendering during the dynamic use of the device.

### BRIEF SUMMARY

The present disclosure aims to overcome the drawbacks of the state of the art by allowing simplified and more economical industrial production of the moving and fixed mechanical components of a magnetized passive haptic device.

To do this, the present disclosure proposes to produce a determined number of notches felt by the user by combining a fixed part and a moving part, each having a minimized number of alternating North/South magnetic poles, preferably less than the desired number of indexed positions, which makes it easier to achieve while remaining passive, that is to say, without using an electric coil and without consuming electric energy.

It is also an object of the present disclosure to propose a simple and economical solution for integrating a position sensor into such a haptic device.

For this reason, in its most general sense, the present disclosure relates to a passive haptic device comprising a first mechanical member moving with respect to a second mechanical member, the first mechanical member having a magnet and a first plurality of magnetized zones spaced periodically according to a pitch P1, the second mechanical member having a second magnet and a second plurality of magnetized zones spaced periodically according to a pitch P2, a force that varies periodically as a function of the relative position of the mechanical members being created by the magnetic interaction between the mechanical members, the magnetic interaction varying according to a period Pt, characterized in that all the magnetized zones of at least one of the mechanical members are magnetized in the same sense.

According to variants, the present disclosure also relates to a haptic interface additionally having one or more of the following features, taken separately or in any technically compatible combination:
the first and second plurality of magnetized zones are integral parts, respectively, of the first magnet and of the second magnet,
at least one of the plurality of magnetized zones is made of a soft ferromagnetic material and magnetized by the magnet integrated into its mechanical member,
the mechanical members are mobile in relative translation,
the mechanical members have the shape of a ring and are movable in relative rotation,
the magnetized zones of the annular mechanical members are magnetized radially, either in the centrifugal or centripetal sense,
the magnetized zones of at least one of the annular mechanical members are diametrically magnetized, the diametrically magnetized ring having two groups of teeth of identical pitch, these groups being separated by a non-integer number of pitches, this number preferably being (x+0.5) pitches where x is a positive integer, the groups of teeth preferentially being centered along a radius in the direction of diametrical magnetization,
the mechanical members have the shape of a disc and are movable in relative rotation,
the first movable mechanical member comprises a ball joint movable in rotation about three orthogonal axes,
the pitch P1 is identical to the pitch P2,
the mechanical air gap located between the mechanical member and the mechanical member is devoid of soft ferromagnetic materials,
the moving mechanical member has a protuberance in the form of a magnet, the field of which is intended to be measured by a magnetosensitive probe in order to provide information on the position of the moving member,
the magnet protuberance and the magnet are made in one and the same part,
the protuberance and the magnet are magnetized in the same direction and the same sense,
at least one of the magnets is produced by injecting plastic material filled with magnet powder,
at least one of the magnets is made of sintered magnet,
the mechanical members have a relative displacement in at least two directions, the relative displacement with respect to a first direction giving rise to the periodically variable force, and the relative displacement with respect to a second direction resulting in a continuously variable force similar to a magnetic stiffness, and
the first mechanical member has two pluralities of periodically spaced magnetized zones according to the same pitch P1 and in that the pluralities of magnetized zones can be mechanically phase-shifted in order to modulate the amplitude of the periodically variable force as a function of the relative position of the mechanical members.

In the present patent, the terms “ring-shaped” or “annular” have the same meaning and designate the geometry of the envelope of a generally tubular part with a height generally less than the diameter.

“Soft ferromagnetic material” will mean a ferromagnetic material with a low coercive field, typically less than 1,000 A/m, and having a relative magnetic permeability greater than 100.

More specifically, the subject of the present disclosure is a passive haptic device comprising a mechanical member that can be moved with respect to a second mechanical member by an action of the user (for example, by being driven in rotation by a finger), the object of the present disclosure being characterized in that the plurality of magnetized zones of at least one of the mechanical members are all magnetized in the same sense. “Same sense” means that for each point of the magnetized zone, the magnetization is carried by a vector m of coordinates (m₁, m₂, m₃), these coordinates being identical in the local coordinate system associated with each point considered, the local coordinate system possibly being expressed in Cartesian, cylindrical or spherical coordinates. In other words, the plurality of magnetized zones of at least one of the mechanical members does not have an alternation of North poles and South poles.

In the most general case, the measurement of the magnetic induction in the mechanical air gap, due to the mechanical member having the plurality of magnetized zones all in the same sense, in the direction of the magnetization vector m and along a path traversing the plurality of magnetized zones, presents a periodic function of fundamental period corresponding to the pitch of the plurality of magnetized zones, the periodic function being able to present harmonics of this fundamental period. During the activation of the haptic device, the pole pitches P1 and P2 not necessarily being equal, the period Pt of the variable magnetic force preferably corresponds to the lowest common harmonic of the periodic function of fundamental period P1 and of the periodic function of fundamental period P2.

In a variant, in order to obtain the periodic function of the magnetic induction, the mechanical members having the plurality of zones magnetized in the same sense are structured by shapes of teeth at the surface delimiting the mechanical air gap. The shapes of teeth are to be taken in the sense of toothing; thus, they do not necessarily have projecting edges and may have an involute shape of a circle. Thus, the measurement of the magnetic induction in the vicinity of this surface presents a continuous component of high amplitude modulated by a periodic function of fundamental period corresponding to the pitch of the plurality of magnetized zones. The surface can be structured by tooth shapes in different ways, for example, directly, by structuring the magnet or by molding using an injection of plastic filled with magnet particles or powder sintering, but also by the addition of ferromagnetic sheets having these tooth shapes, produced by stamping or machining. These production techniques are non-limiting to the present disclosure.

In a variant with cylindrical geometry, for which the mechanical members are rings according to the previous teachings, so as to obtain the periodic function of the magnetic induction, the mechanical member having the plurality of zones magnetized in the same sense is magnetized according to a transverse diametrical direction, that is to say, in one and the same sense according to a Cartesian coordinate system. The mechanical member is structured by two groups of teeth at its surface facing the air gap. The groups of teeth have the same pole pitch corresponding to the pitch of the magnetized zone, and are spaced apart by a distance equal to an integer number of the pitch of the magnetized zone plus a half pitch. Thus, the measurement of the magnetic induction in the vicinity of the surface, along a circular contour concentric with the ring, presents a sinusoidal component of high amplitude and periodicity 1 modulated by two pseudoperiodic functions of lower amplitude and fundamental period corresponding to the pitch of the plurality of magnetized zones, the pseudoperiodic functions being phase-shifted by a half-period.

In another variant, the space located in the vicinity of the surfaces is devoid of parts made of soft ferromagnetic material. This space having the greatest variations in magnetic induction, this configuration is advantageous for limiting the losses by induced currents that slow down the device when it is used in a pulsed manner.

In another variant, the mechanical members have a magnet support that can perform different functions, for example, for the mechanical interfacing of the mechanical members, or to increase the inertia of the mechanical members or even for purely cosmetic reasons.

### BRIEF DESCRIPTION OF THE DRAWINGS

Other features and advantages of the present disclosure will become clear upon reading the following detailed embodiments, with reference to the accompanying figures, which respectively show:

FIG. 1A is a sectional view of a device according to a first rotary embodiment of the present disclosure;

FIG. 1B is a simulation of the magnetic induction in the mechanical air gap of a mechanical member of the device shown in FIG. 1A;

FIG. 2A is a sectional view of a device according to a second rotary embodiment of the present disclosure;

FIG. 2B is a simulation of the magnetic induction in the mechanical air gap of the external member shown in FIG. 2B;

FIG. 3 is a partial sectional view of a device according to a third rotary embodiment of the present disclosure;

FIG. 4 is a perspective view of a device according to a rotary embodiment of the present disclosure with axial coupling;

FIG. 5 is a rear perspective view of the position detection system of a device according to a rotary embodiment of the present disclosure;

FIG. 6 is a perspective view of a device according to a linear embodiment of the present disclosure;

FIG. 7 is a perspective view of a device according to a spherical embodiment of the present disclosure;

FIG. 8 is a sectional view of a device according to a fourth rotary embodiment of the present disclosure;

FIG. 9 is a sectional view of a device according to a fifth rotary embodiment of the present disclosure;

FIG. 10 is a partial sectional view of a device according to a sixth rotary embodiment of the present disclosure;

FIGS. 11A and 11B are perspective views of a device according to a seventh rotary embodiment of the present disclosure, and showing different functional positions;

FIGS. 12A and 12B are perspective views of a device according to an eighth rotary embodiment of the present disclosure and showing different functional positions;

FIG. 13 is a partial sectional view of a device according to a ninth rotary embodiment of the present disclosure;

FIG. 14 is a partial sectional view of a device according to a tenth rotary embodiment of the present disclosure.

### DETAILED DESCRIPTION

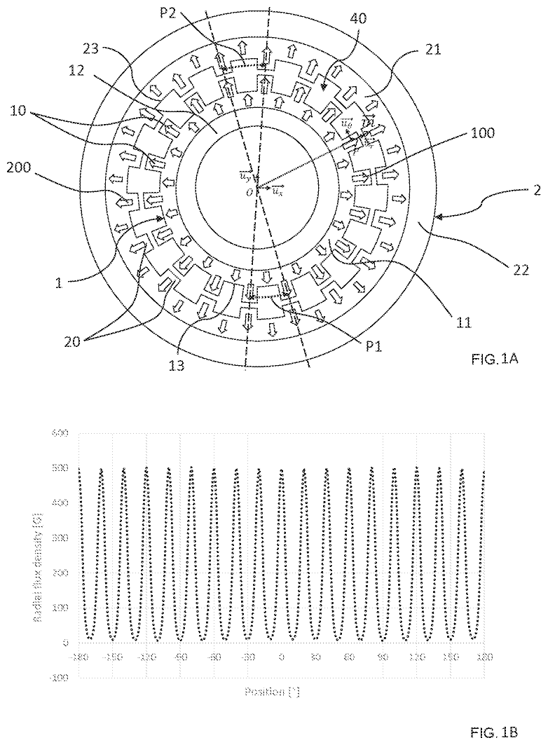

FIG. 1A shows a partial sectional view of a first embodiment of a haptic device according to the present disclosure with rotary actuation having mechanical members (1, 2). In this embodiment, a first mechanical member (1) of annular shape is housed concentrically inside a second mechanical member (2) also of annular shape. The mechanical components (1, 2) are characterized in that they each comprise an annular magnet (11, 21), each of the magnets (11, 21) having a plurality of magnetized zones (10, 20) spaced periodically according to respective angular pitches P1 and P2. The magnetized zones (10) interact with the magnetized zones (20) so as to produce a variable force of period Pt as a function of the relative position of the mechanical members (1, 2). In the presented embodiment, the angular pitches P1 and P2 are equal and produce a variable force of period Pt=P1=P2. This embodiment is also characterized in that each of the magnetized zones (10, 20) does not have alternating North and South magnets, but has the same direction of radial magnetization and the same sense. Thus, for any point P of the plurality of magnetized zones (10, 20) of the magnets (11, 21), the vector OP is always collinear with the magnetization vector \vec{m}, the point O being the center of the annular mechanical members (1, 2), the magnetization vector m then always being expressed with the cylindrical coordinates (m₁, m₂=0, m₃=0) in a local coordinate system (\vec{u}ᵣ,\vec{u}₀,\vec{u}_{z}) specific to the point P, m₁ that may vary but that always has the same sign or is equal to zero. For this type of magnetization, all of the inner cylindrical surfaces on the one hand and the outer cylindrical surfaces on the other hand of each of the annular magnets (11, 21) constitute a pole whose polarities are opposite, the magnetic field looping back between these two poles in the axial (“out of plane”) direction. Advantageously, the outer periphery of the magnet (11) and the inner periphery of the magnet (21) are structured by tooth shapes to form the magnetized zones (10, 20). Thus, as illustrated in FIG. 1B, for the mechanical components (1, 2) taken separately, the induction measured in the radial direction along a circular contour close to the magnetized zones (10, 20) presents a DC component modulated by a periodic function of fundamental period corresponding to the angular pitch (P1, P2) of the magnetized zones (10, 20). When the mechanical components (1, 2) are assembled, the measurement of the radial induction along a circular contour located in the mechanical air gap (40) presents a continuous component modulated by the periodic functions of fundamental periods P1 and P2, respectively, these functions being out of phase by the relative rotational displacement of the mechanical members (1) and (2).

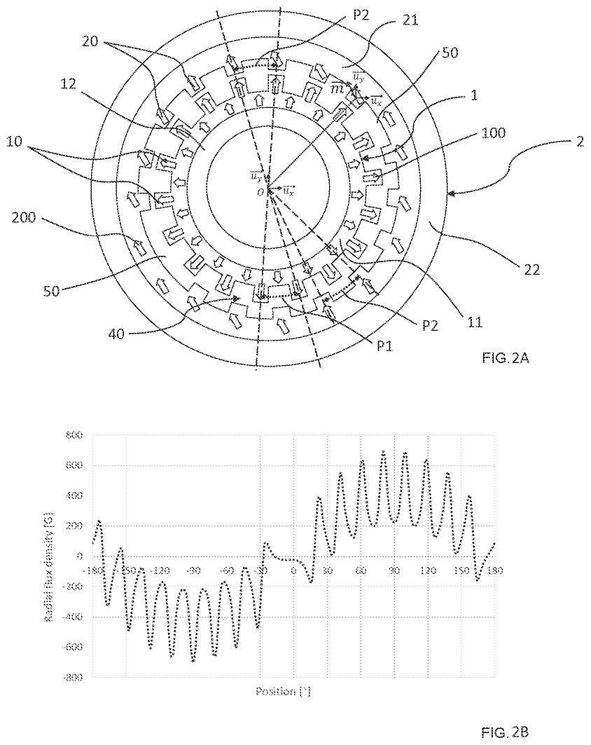

FIG. 2A shows a partial sectional view of a second embodiment with rotary actuation close to the previous embodiment shown in FIG. 1A. It differs from the first embodiment in that the magnet (21) of the mechanical member (2), i.e., the outer ring, has a transverse diametrical direction of magnetization. Thus, for any point P of the plurality of magnetized zones (20) of the magnets (21), the vector \vec{OP} is always collinear with the magnetization vector \vec{m}, the point O being the center of the annular mechanical components (1, 2), the magnetization vector m then always being expressed with the Cartesian coordinates (m₁, m₂=a×m₁, m₃=0) in a global coordinate system (uₓ,u_{y},u_{Z}), a being a constant and m₁ being able to vary, but always having the same sign or being equal to zero. Advantageously, the inner periphery of the magnet (21) is structured by tooth shapes divided into two groups of teeth separated by areas devoid of teeth (50) to form the magnetized zones (20). Within each of the groups of teeth, the pitch between two teeth is identical and equal to the angular pitch (P2), and the two groups of teeth are preferably out of phase by half an angular pitch (P2). Thus, as shown in FIG. 2B, for the diametrically magnetized mechanical member (2), the induction measured in the radial direction along a circular contour close to the magnetized zones (20) has a sinusoidal component of periodicity 1 of high amplitude modulated by two pseudoperiodic functions of lower amplitude and of the same fundamental frequency corresponding to the angular pitch (P2), one modulating the positive alternation of the sinusoidal component of periodicity 1, the other modulating the negative alternation of the sinusoidal component of periodicity 1, the two pseudoperiodic functions being out of phase by a half period. The phase shift of the groups of teeth by a half angular pitch (P2) is not limiting; it makes it possible to maximize the magnetic force when the device is actuated in rotation, the force being zero when the groups of teeth are perfectly in phase.

FIG. 3 shows an embodiment similar to the one shown in FIG. 2A. It differs in that the characteristics of the inner and outer ring magnets are reversed.

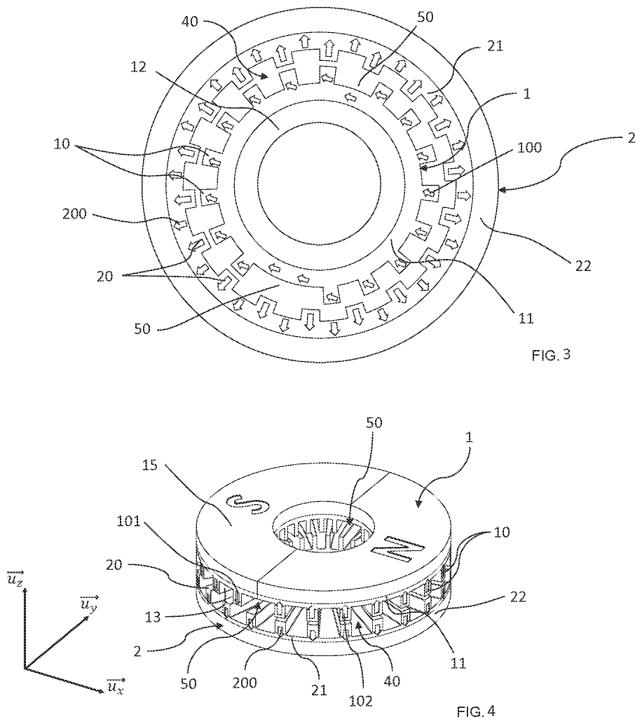

FIG. 4 shows an embodiment close to the one illustrated in FIG. 2A. This embodiment is a transposition into an axial version of the radial rotary version shown in FIG. 2A. This embodiment differs in that the mechanical members (1, 2) are discs in relative rotary motion and separated by a mechanical air gap (40) in the axial direction. The mechanical member (2) has a magnet (21), comprising a plurality of magnetized zones (20) that are all magnetized in the same axial direction and in the same sense (200). Thus, for any point P of the plurality of magnetized zones (20) of the magnets (21), the magnetization vector m is always collinear with the vector The mechanical member (2) is characterized in that the surface of the plurality of magnetized zones facing the mechanical air gap (40) is structured by shapes of teeth spaced apart by the same pitch P2 and are opposite the second mechanical member (1). The second mechanical member (1) also has a magnet (11), comprising a plurality of magnetized zones (10) all in the same direction and whose surface facing the mechanical air gap (40) is structured by two groups of teeth of the same pitch P1, these groups of teeth ideally being separated from zones devoid of teeth (50) and separated by a whole number of pitches P1 plus a half pitch. The plurality of magnetized zones within a group of teeth has the same magnetization sense (101) opposite the magnetization sense (102) of the plurality of magnetized zones within the second group of teeth. The two groups of teeth are thus magnetically out of phase by a half period and constitute the two pseudomagnetic periods, the significance of which is explained in the description of FIG. 2A. The magnet protuberance (15) located in the upper part of the moving part can advantageously be a sub-part of the magnet (11) and have the same magnetization as the groups of teeth located below. This magnetic alternation created on the magnet protuberance (15) can be used as a field source for a magnetosensitive position sensor that would be located close to the moving part (1), which constitutes an integration solution at greatly reduced cost, the magnet (11) being able to be magnetized entirely in a single operation to provide a double functionality both to achieve the haptic effect interacting with the magnet (21) and to provide the position information of the moving mechanical member (1).

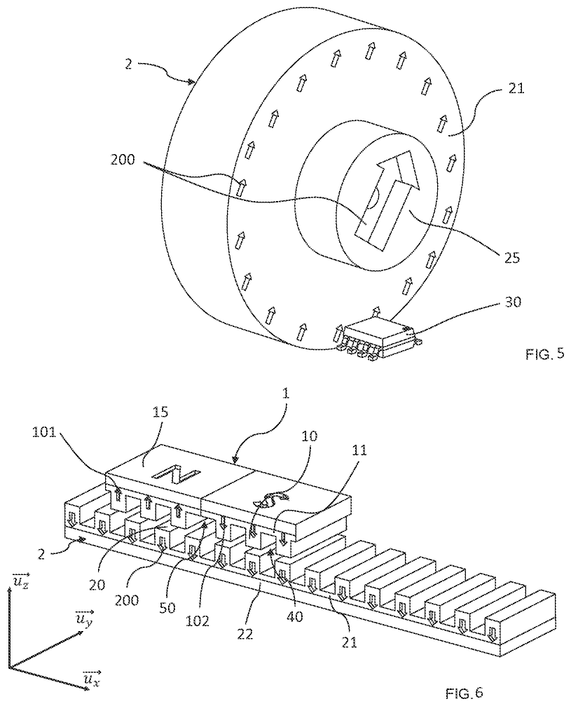

FIG. 5 shows a mode of integration of a magnetic sensor intended to measure the absolute angular position of the movable mechanical member (2) for an embodiment with rotary actuation. This mode of integration is compatible with all the previous embodiments, but is illustrated according to the second embodiment shown in FIG. 2A, the magnet support (22) not being shown. In this embodiment, the mechanical member (2) is movable and the magnet (21) is closed at one axial end and has a cylindrical protuberance (25) magnetized in a transverse diametrical direction (200). The magnetic field of the protuberance (25) is measured by a magnetosensitive probe (30) so as to obtain the absolute angular position of the mechanical member (2).

This embodiment is particularly advantageous in the case where the plurality of magnetized zones (20) has a transverse diametrical direction of magnetization. In this case, the entire magnet (21) has a single direction (200) of magnetization, which makes the construction of the magnetization tool particularly simple and reinforces the magnetic field measured by the magnetosensitive probe (30).

FIG. 6 shows an embodiment according to the present disclosure with linear actuation. This is the linear transposition of the version explained in FIG. 2A in the radial rotary version or in FIG. 4 in the axial rotary version. This time, the mechanical components (1, 2) are movable in relative linear displacement and separated by a planar mechanical air gap (40). The mechanical member (2) has a magnet (21), comprising a plurality of magnetized zones (20) that are all magnetized in the same vertical direction and in the same sense (200). Thus, for any point P of the plurality of magnetized zones (20) of the magnets (21), the magnetization vector m is always collinear with the vector \vec{u}_{z′}. The mechanical member (2) is characterized in that the surface of the plurality of magnetized zones facing the mechanical air gap (40) is structured by shapes of teeth spaced apart by the same pitch (P2) and are opposite the second mechanical member (1). The second mechanical member (1) also has a magnet (11), comprising a plurality of magnetized zones (10) all in the same direction and whose surface facing the mechanical air gap (40) is structured by two groups of teeth of the same pitch P1, these groups of teeth ideally being separated by a whole number of pitches P1 plus a half pitch. The plurality of magnetized zones within a group of teeth has the same magnetization sense (101) opposite the magnetization sense (102) of the plurality of magnetized zones within the second group of teeth. The two groups of teeth are thus magnetically out of phase by a half period and constitute the two pseudomagnetic periods, the significance of which is explained in the description of FIG. 2A. The magnet protuberance (15) located in the upper part of the moving part can advantageously be a sub-part of the magnet (11) and have the same magnetization as the groups of teeth located below. This magnetic alternation created on the magnet protuberance (15) can be used as a field source for a magnetosensitive position sensor that would be located close to the mechanical member (1), which constitutes an integration solution at greatly reduced cost, the magnet (11) being able to be magnetized entirely in a single operation to provide a double functionality both to achieve the haptic effect interacting with the magnet (21) and to provide the position information of the moving mechanical member (1).

FIG. 7 shows an embodiment according to the present disclosure with rotary actuation in three orthogonal directions. This embodiment can be seen as the combination of three haptic devices as shown in FIG. 1A. Each of the three devices, made up on the one hand of tracks respectively secured to a fixed mechanical member (2) and on the other hand to a movable mechanical member (1) attached to a control device actuated by the user. The first haptic device, acting in a first direction, comprises tracks (13a) and (23a) magnetized according to the characteristics of FIG. 1A. The second device, in a second direction of actuation, comprises tracks (13b) and (23b). The last pair (13c) and (23c) of toothed magnets creating the haptic effect in the third direction. The tracks (13a, 13b, 13c) run through the plurality of magnetized zones (10) of the magnet (11), the tracks (23a, 23b, 23c) run through the plurality of magnetized zones (20) of the magnet (21), at least one of the magnetized zones (10, 20) all being magnetized in the same sense. Thus, by analogy with the previous embodiments, for any point P of the plurality of magnetized zones (10, 20) all in the same sense of the magnets (11, 21), the vector \vec{OP} is always collinear with the magnetization vector \vec{m}, the point O being the center of the spherical mechanical components (1, 2), the magnetization vector \vec{m} always being expressed with the spherical coordinates (m₁, m₂=0, m₃=0) in a local coordinate system (\vec{u}ᵣ,\vec{u}_{θ},\vec{u}_{ϕ}) specific to the point P, m₁ that may vary but that always has the same sign or is equal to zero.

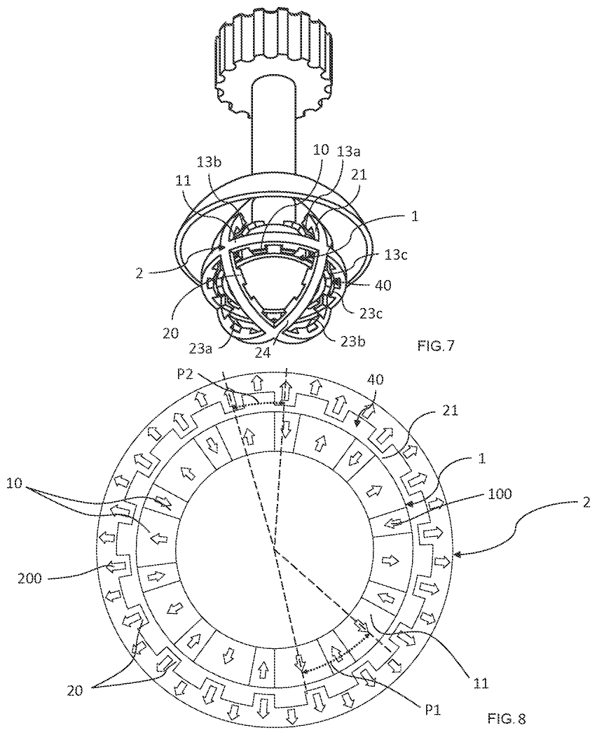

FIG. 8 shows an embodiment similar to the one shown in FIGS. 1A and 2A. It differs in that the mechanical member (1), i.e., the inner ring, has a plurality of magnetized zones (10) having alternating North and South poles and in that the angular pitches P1 and P2 are different. Thus, the period Pt corresponds to a common harmonic of the periodic magnetization functions of period P1 and P2 of the inner and outer rings. One of the means used to control the amplitude of the haptic effect is to play on the amplitude of the harmonics of the magnetization functions. In the illustrated case, the plurality of magnetized zones (10) has alternations of North and South poles of different width; this has the effect of increasing the amplitude of the magnetization harmonics of even order. Of course, any other way of controlling the harmonics of magnetizations that a person skilled in the art could think of, such as the particular design of the inductor or the structuring of the magnetized zones, is envisaged.

FIG. 9 shows an embodiment similar to the one shown in FIG. 1A; it differs in that the plurality of magnetized zones (10) of the mechanical member (1) has alternating North and South poles. This embodiment is not limiting, and a configuration with the outer ring comprising alternating North/South poles and the inner ring a toothed unipolar magnet is also possible.

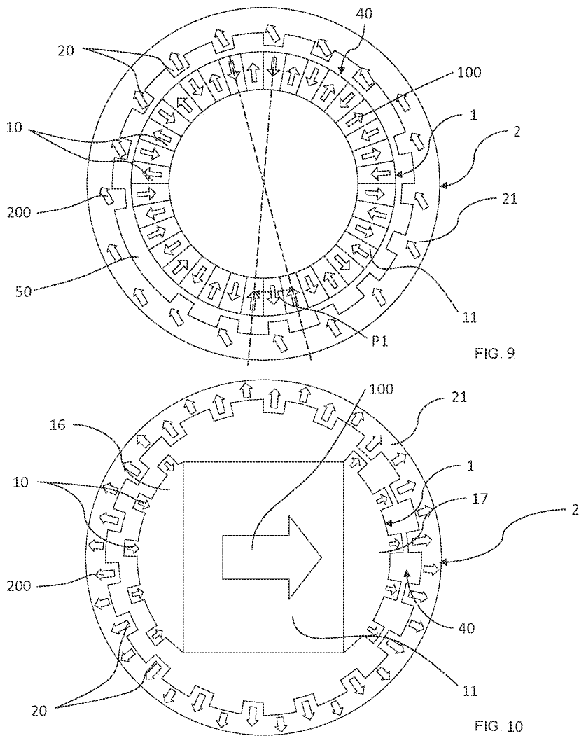

FIG. 10 shows an embodiment similar to the one shown in FIG. 2A. It differs in that the plurality of magnetized zones (10) of the mechanical member (1) is produced by cutting teeth, spaced apart by a pitch P1, in two semi-cylindrical parts (16, 17) having a section in the shape of an arc of a circle, made of magnetically soft ferromagnetic material, coupled to a magnet (11) of parallelepipedal shape. The magnet (11) is magnetized in a direction (100) in the direction defined by the plane of symmetry of the two poles made of soft ferromagnetic material. To create the desired haptic periodicity Pt, the plurality of magnetized zones (20) of the movable mechanical member (2) is produced by structuring in the form of teeth of the magnet (21) spaced apart by a pitch P2, with Pt=P1=P2, and magnetized in the same radial direction (200). A configuration where the characteristics of the inner and outer rings are swapped is also envisaged.

FIGS. 11A and 11B show an alternative embodiment according to the present disclosure with rotary actuation. This embodiment differs from the embodiment shown in FIG. 2A in that the mechanical member (1), in the form of an inner ring, has two wafers superposed axially, the two wafers each having a plurality of magnetized zones (10a) and (10b) that are magnetized radially. Advantageously, the two wafers can be temporarily separated and the plurality of magnetized zones (10a) of the first wafer can be out of phase with the plurality of magnetized zones (10b) of the second wafer of the mechanical member (1). Thus, FIG. 11A shows the configuration for which the plurality of magnetized zones (10a) and (10b) are in phase opposition, which has the effect of minimizing the notching effect by magnetic interaction of the plurality of magnetized zones (10a, 10b) with the plurality of magnetized zones (20) of the mechanical member (2), when the mechanical members (1, 2) are set in relative motion. In the presented embodiment, the magnetized zones (10a and 10b) are mounted on the same axis. Their phase shift is achieved by way of an arm (14) secured to the first wafer, comprising the plurality of magnetized zones (10a). The phase shift can be adjusted when the locking device (19) is released, the arm (14) being able to be moved angularly, while the second wafer comprising the plurality of magnetized zones (10b) is held fixed relative to the haptic device by way of a locking device (19).

The presented phase-shifting device is entirely mechanical, but it is, however, possible to imagine that it could be achieved by way of an electromagnetic actuator integrated into the mechanical member (1).

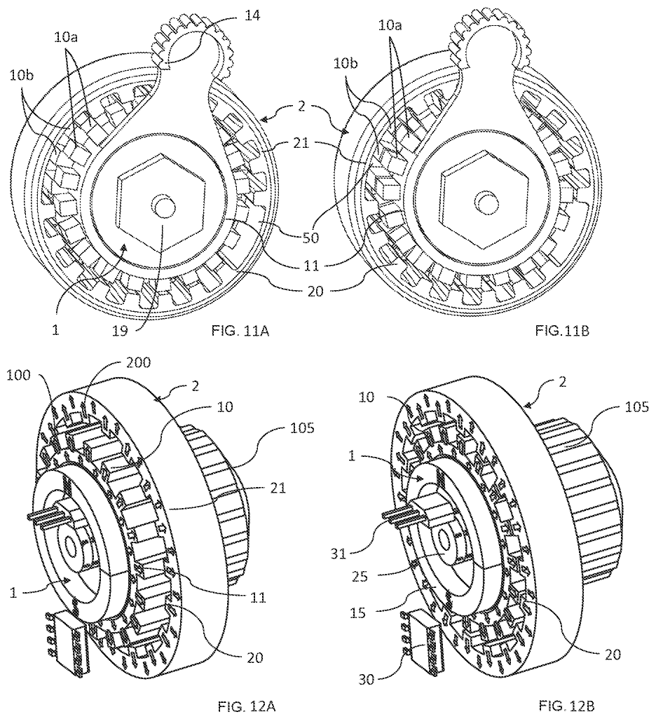

FIGS. 12A and 12B show a variant embodiment according to the present disclosure with rotary and axial actuation. This embodiment differs from the embodiment shown in FIG. 1A in that the mechanical member (1) has an additional degree of freedom in the axial direction. The cooperation of the plurality of magnetized zones (10) of the mechanical member (1) with the plurality of magnetized zones (20) of the second mechanical member (2) produces a stiffness effect during the relative movement of the two mechanical members (1 and 2) in the axial direction. Thus, FIG. 12A shows the axial position of the mechanical member (1) for which the axial return force is maximal between the two mechanical members (1, 2) and FIG. 12B shows the stable position for which the return force is zero. For the variant presented, the second mechanical member (2) is fixed and the first mechanical member (1) can be moved axially and in rotation using an actuation interface (105), secured to the mechanical member (1), and being in the form of an axial cylindrical protrusion. On the side opposite the actuation interface (105), the mechanical member (1) has two magnet protuberances (15, 25), the first being annular and the second cylindrical in shape and housed within it. These two protuberances each cooperate with a magnetosensitive probe (30, 31), the first magnetosensitive probe (30) being able to measure, in cooperation with the magnet protuberance (15) having a diametrical or rotating magnetization, the relative rotary displacement of the two mechanical members (1 and 2). The second magnetosensitive probe, in cooperation with the magnet protuberance (25) having an axial magnetization, is capable of measuring the relative axial displacement between the two mechanical members (1 and 2). The axial displacement with elastic return, associated with detection of the displacement, can make it possible to perform a selection button function.

Of course, this variant with axial displacement is not limited to the embodiment based on the one presented in FIG. 1A, but extends to all versions of a notching device that are compatible with those skilled in the art.

Thus, the detection of the axial position does not necessarily require the addition of a second magnet and a second probe, as the person skilled in the art can arrange the magnetosensitive probe (30) in a specific way and choose an appropriate magnetization of the magnet protuberance (15) so as to obtain the angular and axial displacement information with this single sensor. The version with two sensors only offers an improvement in the resolution of the measurement of the displacements.

Finally, it is not necessary for the same mechanical member to have both the degree of rotational freedom and the degree of freedom in axial translation; the person skilled in the art could imagine that one mechanical member has only an axial movement and the other mechanical member has only a rotational movement, in which case the person skilled in the art would then know how to correctly arrange the magnet(s) cooperating with the magnetosensitive probe(s) in order to measure the various displacements.

Note that the notching effect decreases with the axial misalignment of the two mechanical members (1, 2); this configuration could then be used to generate different haptic feelings, a notching mode when the mechanical members (1, 2) are aligned axially and a mode without notching, called freewheel, when they are misaligned.

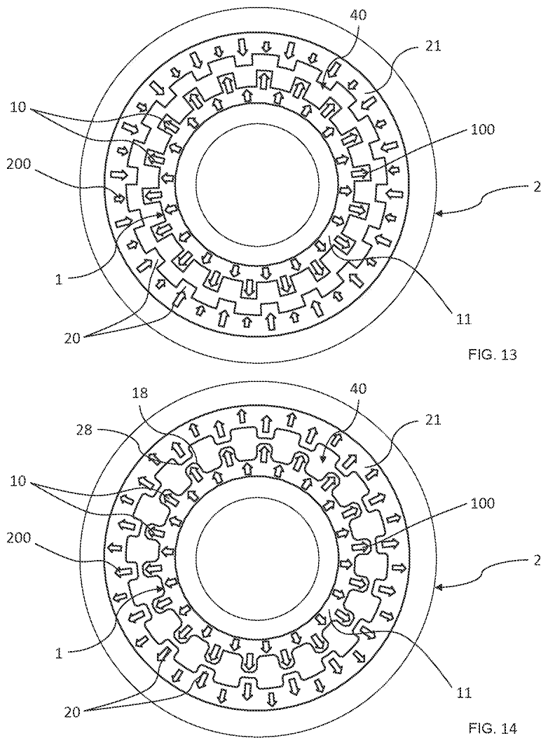

FIG. 13 shows a variant embodiment according to the present disclosure with rotary actuation. This embodiment differs from the embodiment shown in FIG. 1A in that the plurality of magnetized zones (10) of the mechanical member (1) has a direction (100) of magnetization opposite that of the plurality of magnetized zones (20) of the second mechanical member (2). This implies that the position of angular magnetic equilibrium between the two mechanical members (1, 2) is obtained when the plurality of magnetized zones (10, 20) are in phase opposition. This configuration also exhibits axial magnetic instability. This effect could be used to obtain an alternative repulsion version of the device shown in FIGS. 12A and 12B.

FIG. 14 shows a variant embodiment according to the present disclosure with rotary and axial actuation. This embodiment differs from the embodiment shown in FIG. 1A in that the plurality of magnetized zones (10, 20) are made in the form of non-projecting teeth, that is to say, having teeth whose angular ends (18, 28) are not sharp-edged, but have a gradual shrinkage in the radial direction, for example, forming a fillet or a chamfer. The shape of these angular ends (18, 28) makes it possible to sculpt the torque profile obtained during the relative movement of the two mechanical members (1, 2), and therefore to personalize the haptic rendering.

1. A passive haptic device comprising a first mechanical member moving with respect to a second mechanical member, the first mechanical member having a magnet and a first plurality of magnetized zones spaced periodically according to a pitch P1, the second mechanical member having a second magnet and a second plurality of magnetized zones spaced periodically according to a pitch P2, a force that varies periodically as a function of the relative position of the mechanical members being created by the magnetic interaction between the mechanical members, the magnetic interaction varying according to a period Pt, wherein all the magnetized zones of at least one of the mechanical members are magnetized in the same sense.

2. The passive haptic device according to claim 1, wherein the first and second plurality of magnetized zones are integral parts, respectively, of the first magnet and of the second magnet.

3. The passive haptic device according to claim 1, wherein at least one of the plurality of magnetized zones is made of a soft ferromagnetic material and magnetized by the magnet integrated into its mechanical member.

4. The passive haptic device according to claim 1, wherein the mechanical members are movable in relative translation.

5. The passive haptic device according to claim 1, wherein the mechanical members have the shape of a ring and are movable in relative rotation.

6. The passive haptic device according to claim 3, wherein the magnetized zones of the annular mechanical members are magnetized radially, either in the centrifugal or centripetal sense.

7. The passive haptic device according to claim 3, wherein the magnetized zones of at least one of the annular mechanical members are diametrically magnetized, the diametrically magnetized ring having two groups of teeth of identical pitch, these groups being separated by a non-integer number of pitches, this number preferably being (x+0.5) pitches where x is a positive integer, the groups of teeth preferentially being centered along a radius in the direction of diametrical magnetization.

8. The passive haptic device according to claim 1, wherein the mechanical members have the shape of a disc and are movable in relative rotation.

9. The passive haptic device according to claim 1, wherein the first movable mechanical member comprises a ball joint movable in rotation about three orthogonal axes.

10. The passive haptic device according to claim 1, wherein the pitch P1 is identical to the pitch P2.

11. The passive haptic device according to claim 1, wherein a mechanical air gap located between the mechanical member and the mechanical member is devoid of soft ferromagnetic materials.

12. The passive haptic device according to claim 1, wherein the moving mechanical member has a protuberance in the form of a magnet, the field of which is intended to be measured by a magnetosensitive probe in order to provide information on the position of the moving member.

13. The passive haptic device according to claim 12, wherein the magnet protuberance and the magnet are made in one and the same part.

14. The passive haptic device according to claim 10, wherein the protuberance and the magnet are magnetized in the same direction and the same sense.

15. The passive haptic device according to claim 1, wherein at least one of the magnets is produced by injecting plastic material filled with magnet powder.

16. The passive haptic device according to claim 1, wherein at least one of the magnets is made of sintered magnet.

17. The passive haptic device according to claim 1, wherein the mechanical members have a relative displacement in at least two directions, the relative displacement with respect to a first direction giving rise to the periodically variable force, and the relative displacement with respect to a second direction resulting in a continuously variable force similar to a magnetic stiffness.

18. The passive haptic device according to claim 1, wherein the first mechanical member has two pluralities of periodically spaced magnetized zones according to the same pitch P1 and in that the pluralities of magnetized zones can be mechanically phase-shifted in order to modulate the amplitude of the periodically variable force as a function of the relative position of the mechanical members.

19. The passive haptic device according to claim 11, wherein the protuberance and the magnet are magnetized in the same direction and the same sense.
